(19) United States
(12) Patent Application Publication
(10) Pub. No.: US 2016/0375606 A1
(43) Pub. Date: Dec. 29, 2016

(54) THREE DIMENSIONAL MULTILAYERED PRINTED SUPER CONDUCTING ELECTROMAGNETS

(71) Applicant: Randall E. Reeves, Farmington Hills, MI (US)

(72) Inventor: Randall E. Reeves, Farmington Hills, MI (US)

(21) Appl. No.: 14/670,872

(22) Filed: Mar. 27, 2015

Related U.S. Application Data
(60) Provisional application No. 61/971,288, filed on Mar. 27, 2014.

(51) Int. Cl. B28B 1/00; B33Y 80/00; H01F 41/02; B28B 17/00; B33Y 50/02; C04B 35/45; B33Y 10/00; B33Y 30/00

(52) U.S. Cl. CPC B28B 1/001; B33Y 10/00; B33Y 80/00; B33Y 30/00; B28B 17/0081; B33Y 50/02; C04B 35/4504; H01F 41/0206; C04B 2235/3225; C04B 2235/3215; C04B 2235/3282

(57) ABSTRACT

The present invention is a method of manufacturing a super conducting electromagnet comprising a 3D printer extruder of the type having an extruder, a liquefier and a nozzle.

### CROSS REFERENCE TO RELATED APPLICATIONS

This application is a completion application of co-pending U.S. Provisional Patent Application Ser. No. 61/971,288, filed Mar. 27, 2014 for “Three Dimensional Multilayered Printed Super Conducting Electromagnets” the disclosure of which is hereby incorporated by reference.

### OVERVIEW OF INVENTION

### Purpose of Invention

Manufacture Super Conducting and Conventional Electromagnets using multiple 3D printing technologies and composite materials.

### Description of Problem(s) Solved by Invention

Traditional superconductors that work at temperature of liquid nitrogen or above (HIS) are made of composite of oxides that are not malleable into shapes used in industrial electromagnets.

### How the Invention is an Improvement Over Existing Technology

Allows non-malleable composites that cannot be used in devices such as electric motors, MRI and generators to be shaped into magnetic field inducing shapes including the dielectric and thermal insulators included in the finished product.

### Groups of People and/or Businesses That Would Use the Invention

Electrical power production to include traditional carbon fuels, wind and hydroelectric. Medical devices to include MRI and traditional test equipment and electronics. Electric motors used in all phases of manufacturing, transportation etc.

### Benefits to Users of Invention

Small extremely powerful devices. Using less electricity than traditional electromagnets.

### Brief Description of Invention

3D Printed Electromagnets to include super conductors and traditional electromagnets.

### DESCRIPTION OF DRAWINGS OF INVENTION

Included in the drawing will be a 3D view, a cross section and the layering process used in conventional 3D printers.

### Brief Description of Figures

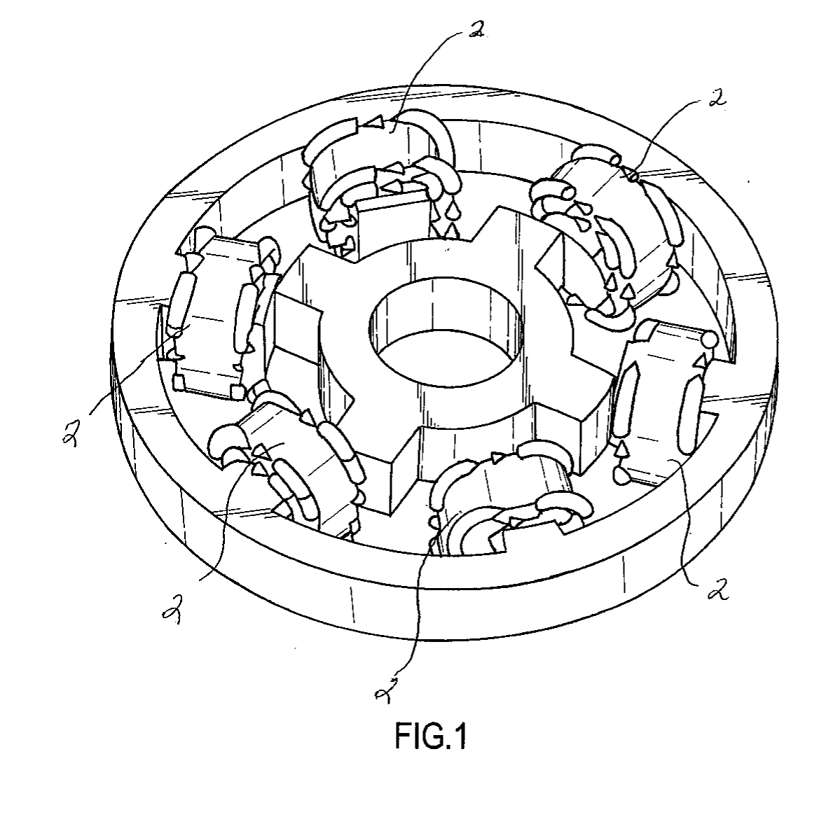

FIG. 1. Three dimensional view of a electric motor and electromagnets used in a conventional electric motor.

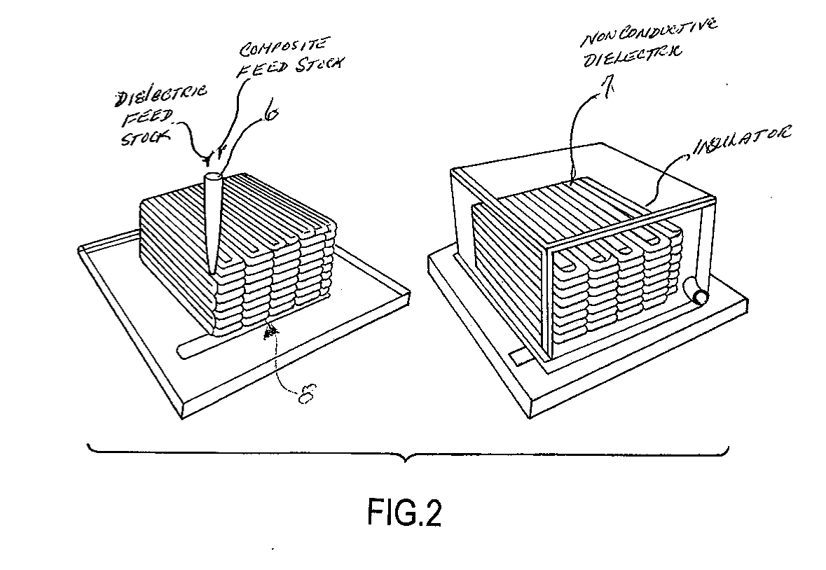

FIG. 2. Cross section of the printing concept to build the electromagnet layer by layer including conductor, dielectric material, thermal insulator and cooling holes.

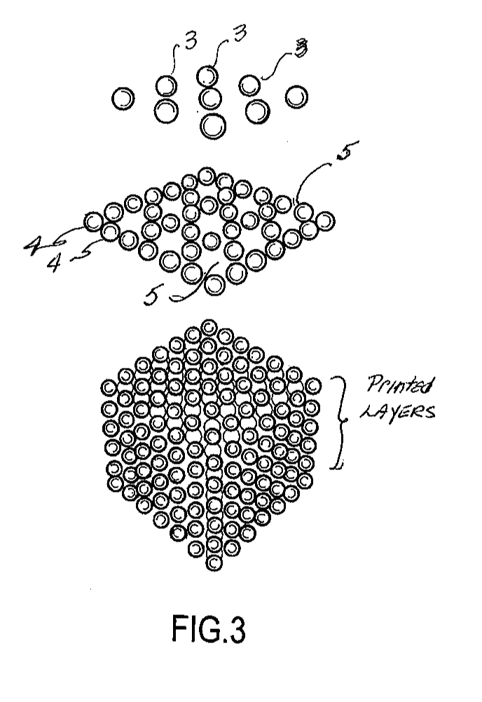

FIG. 3. 3D Printing process.

The Applicant has attached the following figures of the invention at the end of this provisional patent application:

Description of FIG. 1: An example of a typical electric motor design having composite magnets installed. Description of FIG. 2: Cross Section of layered process in printing. Description of FIG. 3: Printing Process showing a continuous extrusion of material and how multiple nozzle's can layer-by-layer print the magnets components.

### Identification of Parts/Components For Invention

| Reference | |
|---|---|
| Numeral | Name of Part |
| 2 | Composite electromagnets super conducting or |
| | conventional. |
| 3 | Dots representing metallic or non-metallic composites. |
| 4 | Dots represent dielectric and thermal insulating |
| | materials. |
| 5 | Holes are also incorporated in the design to allow |
| | cooling fluids or gas. |
| 6 | Depiction of multiple printer heads used to print the |
| | layers. |
| 7 | Out printed area of electric and thermal insulation |
| | material added layers. |
| 8 | Example of a conductive coil built layer by layer. |

### DETAILED DESCRIPTION OF INVENTION

### Description of the Parts of the Invention

The finished product consist of formulations of material to create layers stacked one on top of the next to create a solid or semi solid three dimensional electromagnet.

The separate parts consist of conductive composite materials and nonconductive material extruded by nozzle's in a three-dimensional pattern to build a complete super conducting or conventional electromagnet to include insulator and thermal insulator to help the efficiency of the cooling fluid or gas circulated through cooling hole left in the finished product.

### Relationship Between the Parts of the Invention

The different materials are extruded from print nozzles as a fluid or solid heated to become fluid or may contains a solvent to allow printing then solidify shortly after printing by evaporation of the solvent. The different compounds are printed as a liquid next to each other and harden as a solid sheet. The next layer is now added on top of the last until a finished product is completed.

### Description of How the Invention Operates/Functions

Power is applied to the conductive coil and a electromagnet field is produced. If the compound is super conducting and a cryogenic fluid is circulated through the cooling holes the magnet will product extremely high magnetic fields.

### Unique Features of Invention

This is the only process to build electromagnets from compounds formulated to be able to be three dimensionally printed using a process that is faster and using material normally not available in traditional manufacturing. The standard method is to use metallic wire (Copper, Aluminum etc.) wound into a coil over an insulator.

### How to Make the Invention

The description of this invention includes this new method to assemble electromagnets from material that would not normally be used to make the electromechanical devices.

Most composite used today for superconductors are made by combining metallic oxides such as YBaCuO (Yttrium, Barium, Copper Oxide) and others as well.

These and other superconductors are powders that can be compressed into solids or heated to form ceramics but are not bendable into wire shapes that are common in normal electromagnets.

Non superconductors (room temperature electromagnets) can be made with the below process as well. And can use metallic powders in a fluid mixture.

All electromagnets are made with the process of winding wire in a coil or stacking plates in patters to product the same effects as a wound coil.

With the use of 3D printing technologies it is possible to use these powder is a solutions for the conductor part of the electromagnet and of a number of liquid compounds the to serve as the dielectric (Non-Conductor) and provide pathways or holes to allow cooling fluids to circulate in the electromagnet.

Both materials, i.e., composite and dielectric are printed at the same time. The solvent in the feed stock dries and hardens and thereafter the layers are baked into a porcelain material, if required.

Taking any electromagnet design and slice it into thousands of layers then put it back together again layer by layer with 3D printing technology using the above described conductor and non-conductor materials that will harden and can also be baked if needed into a ceramic.

### Alternative Embodiments of Invention

Any method that would allow you to build one layer at a time in two dimensions that could then be layer one on top of the last to form a three dimensional object that would preform the same function of an electromagnet.

1. A method of manufacturing a super conducting electromagnet, comprising;
(a) preparing a superconductor metal oxide powder mixture;
(b) admixing the powder mixture with a non-conductive liquid to define a feed stock;
(c) providing a 3D printer extruder of the type having an extruder, a liquefier and a nozzle;
(d) inputting an image of the desired configuration of the magnet to the printer;
(e) feeding the feedstock to the printer;
(f) providing a platform disposed on the printer;
(g) depositing a first quantity of feedstock from the nozzle onto the platform, the first quantity solidifying to define a first layer of the magnet, the first quantity being deposited in conformity with the desired configuration; and
(h) repeating steps (e) and (f) until a final electromagnet is obtained.
